(19) United States
(12) Patent Application Publication
(10) Pub. No.: US 2012/0268091 A1
(43) Pub. Date: Oct. 25, 2012

(54) SWITCHING CIRCUIT DEVICE AND POWER SUPPLY DEVICE HAVING SAME

(75) Inventor: Yoshihiro Takemae, Yokohama (JP)

(73) Assignee: FUJITSU SEMICONDUCTOR LIMITED, Yokohama-shi (JP)

(21) Appl. No.: 13/361,216

(22) Filed: Jan. 30, 2012

(30) Foreign Application Priority Data
Apr. 19, 2011 (JP) 2011-092722

(51) Int. Cl. G05F 1/10

(52) U.S. Cl. 323/272

(57) ABSTRACT

A switching circuit device provided between a first node and a second node within a power supply circuit, an inductor being coupled to the first or second node, the switching circuit device has: a first transistor that is provided between the first node and the second node and has a first gate width; a second transistor that is provided in parallel with the first transistor between the first node and the second node and has a second gate width larger than the first gate width; and a driving signal generation circuit, which, in response to a control signal generated according to an output voltage of the power supply circuit, outputs a first driving signal which drives the first transistor on and off, and a second driving signal which drives the second transistor on and off, with different timings between the first driving signal output and the second driving signal output.

### CROSS-REFERENCE TO RELATED APPLICATION

This application is based upon and claims the benefit of priority of the prior Japanese Patent Application No. 2011-092722, filed on Apr. 19, 2011, the entire contents of which are incorporated herein by reference.

### FIELD

The embodiment relates to a switching circuit device and to a power supply device having such a switching circuit device.

### BACKGROUND

Power supply circuit generates a step-up power supply which raises the voltage of an AC power supply or DC power supply, or a step-down power supply which lowers the voltage. A power supply circuit has an inductor, a switching circuit device which switches the inductor current on and off, and a control signal generation circuit which generates a control signal to control this switching. This control signal generation circuit monitors an output voltage of the power supply circuit and generates a control signal such that the output voltage becomes a desired voltage. The power supply circuit generates an output voltage at the desired voltage through the switching on and off of the inductor current by the switching circuit device according to this control signal.

A comparatively high voltage is applied to the switching circuit device, and thus the switching circuit device has a high-voltage power semiconductor device such as a power MOSFET or an IGBT (Insulated Gate Bipolar Transistor), and further has a driving signal generation circuit to generate a driving signal to drive the on and off switching. The driving signal generation circuit takes as input the control signal supplied from the control signal generation circuit, and generates a driving signal to drive the power semiconductor device.

A power supply circuit is disclosed in Japanese Patent Laid-open No. 08-32064 and Japanese Patent Laid-open No. 11-150465.

In a power supply device, the switching circuit device switches on and off a large current flowing in the inductor. Consequently a high noise voltage occurs across parasitic inductance within the power supply device accompanying rapid changes in the large current, and large amounts of energy are emitted as electromagnetic waves. If the on resistance of the switching transistor is made high in order to avoid such occurrences, losses are increased.

### SUMMARY

A switching circuit device provided between a first node and a second node within a power supply circuit, with an inductor being coupled to the first or second node, the switching circuit device has: a first transistor that is provided between the first node and the second node and has a first gate width; a second transistor that is provided in parallel with the first transistor between the first node and the second node and has a second gate width larger than the first gate width; and a driving signal generation circuit, which, in response to a control signal generated according to an output voltage of the power supply circuit, outputs a first driving signal which drives the first transistor on and off, and a second driving signal which drives the second transistor on and off, with different timings between the first driving signal output and the second driving signal output.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the circuit and operation waveforms of a power supply device having a switching circuit device.

FIG. 2 is a circuit diagram of a power supply device having the switching circuit device of the first embodiment.

FIG. 3 is an operation waveform diagram of the switching circuit device 20 of FIG. 2.

FIG. 4 is a circuit diagram of the power supply device in this embodiment.

FIG. 5 illustrates a first circuit example of the driving signal generation circuit in this embodiment.

FIG. 6 illustrates a second circuit example of the driving signal generation circuit in this embodiment.

FIG. 7 is a cross-sectional view of a chip comprising a switching circuit device in this embodiment.

FIG. 8 is a circuit diagram of the power supply device of a second embodiment.

### DESCRIPTION OF EMBODIMENTS

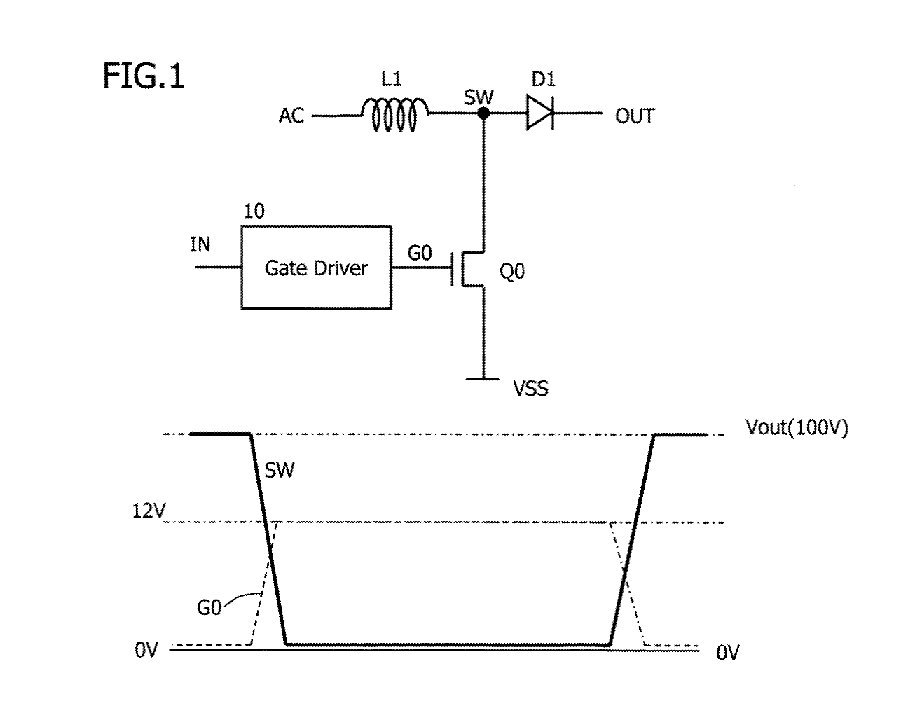

FIG. 1 illustrates the circuit and operation waveforms of a power supply device having a switching circuit device. The power supply device has an inductor L1 coupled to an AC power supply AC, a diode D1 which is a unidirectional element, provided between the inductor L1 and the output OUT, and a connection node (first node) SW connecting the inductor L1 and the diode D1. The power supply device further has a switching transistor Q0 provided between the first node SW and a second node which is ground or another reference power supply VSS, and a gate driver 10 which generates a driving signal G0 applied to the gate of the switching transistor Q0 according to a control signal IN. The switching transistor Q0 is a high-voltage power transistor to which a high voltage is applied, and which turns on and off a large current flowing in the inductor L1. In this example, an N-channel MOSFET is used.

As illustrated in the operation waveform diagram, when the gate driver 10 raises the driving signal G0 from ground potential to the 12 V power supply voltage in response to the control signal IN, the transistor Q0 begins conducting, and a large current flows from the AC power supply AC to the inductor L1, first node SW, transistor Q0, and ground power supply VSS. As a result, the first node SW falls to ground potential, and energy is stored in the inductor L1 through the passing of a large current.

When in response to the control signal IN the gate driver 10 lowers the driving signal G0 from the power supply voltage 12 V to ground potential, the transistor Q0 enters the non-conducting state, and current flowing in the transistor Q0 is turned off. At this time, the inductor L1 continues to supply current from the AC power supply AC toward the output terminal OUT by means of stored energy. As a result, the first node SW and output voltage Vout rise to a high potential.

By repeating such on-off operation of the transistor Q0, the voltage Vout at the output terminal OUT, which at the start of operation had been at low potential, is stepped up to a high DC voltage.

The transistor Q0 is a high-voltage power MOSFET, the structure of which differs from that of an ordinary-voltage MOSFET within the gate driver 10. Hence the transistor Q0 and the gate driver 10 are not provided on the same chip, and are provided on different chips. Consequently the number of components comprised by the power supply devices is increased.

Further, it is desirable that the on resistance of the transistor Q0 be as low as possible. This is because if the on resistance is high, the loss in the current flowing from the inductor L1 through the transistor Q0 when the transistor Q0 is conducting is large, and the efficiency of the power supply device is reduced.

On the other hand, it is desirable that when the transistor Q0 is switched the change in current be as small as possible. This is because, when the change in current upon switching from off to on and from on to off is large, the voltage V occurring across parasitic inductance Lp in the path of current flowing in the inductor L1 and the transistor Q0, V=Lp(di/dt) (where i is the current and t is time), becomes high. And moreover, electromagnetic noise generated from the parasitic inductance Lp is large. This parasitic inductance Lp is formed by, for example, bonding wires within the package accommodating the chip with the transistor Q0, metallization within the chip, and similar.

Hence it is desirable that the on resistance of the transistor Q0 be made high during the interval in which the transistor Q0 changes from off to on and the first node SW falls from a high voltage to ground VSS, that the speed of the change in current (di/dt) flowing from the first node SW to the second node VSS be made as slow as possible, and that the voltage and electromagnetic noise generated by the parasitic inductance Lp be kept as small as possible. The same is true when the transistor Q0 changes from on to off and the first node SW rises from ground VSS to a high voltage. On the other hand, after the voltage change at the first node SW has completed and the potential goes to ground potential VSS, during the interval while the on current is flowing in the transistor Q0, it is desirable that the on resistance be kept low and losses be reduced.

The on resistance of the transistor Q0 depends on the transconductance gm, and depends on the ratio W/L of the transistor gate width W and channel length L, and on the difference Vgs-Vth between the gate-source voltage Vgs and the threshold voltage Vth. By inserting a resistance between the gate driver 10 and the gate of the transistor Q0, it would be expected that the rising and falling of the gate driving signal will be blunted, the transconductance gm during switching will be reduced, and the transconductance gm after the first node SW has reached ground VSS will be increased.

However, even when a resistance element is provided between the gate driver 10 and the transistor Q0 formed on different chips, it is not easy to adjust the transconductance gm of the transistor Q0 to a desired characteristic. Further, the control of the transconductance gm of the transistor Q0 which is desired differs according to the size of the inductor L1 in the power supply device in which the switching transistor Q0 is provided, and precise control through a resistance element is difficult.

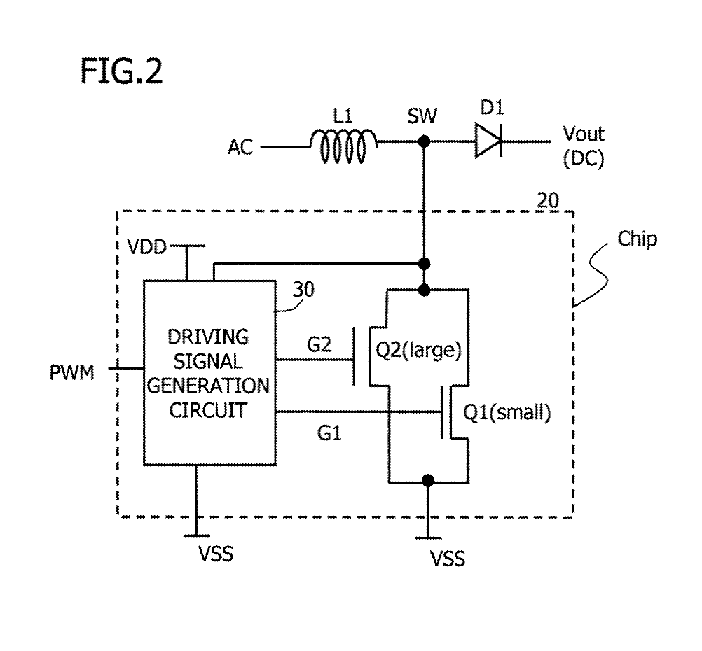

FIG. 2 is a circuit diagram of a power supply device having the switching circuit device of the first embodiment. This power supply device is a step-up device, which steps up the AC input voltage AC to generate a high output voltage Vout. The input voltage may be a DC voltage as well. Similarly to FIG. 1, an inductor L1 and diode D1 are provided, and a switching circuit device 20 is provided between the first node SW, which is a connection node between these, and a second node VSS at ground.

The switching circuit device 20 has a first switching transistor Q1 with a small gate width W and a second switching transistor Q2 with a larger gate width W. These transistors Q1 and Q2 are provided in parallel between the first node SW and the second node VSS. That is, the transistor size W/L of the second transistor Q2 is larger than that of the first transistor Q1, and the transconductance gm is higher and on resistance is smaller when the same gate voltage is applied.

Further, the switching circuit device 20 has a driving signal generation circuit 30 which generates driving signals G1 and G2 to drive the gates of the two transistors Q1 and Q2 according to a control signal PWM. This driving signal generation circuit 30 outputs, shifted in time, a first driving signal G1 which drives the first transistor Q1 to turn on and off, and a second driving signal G2 which drives the second transistor Q2 to turn on and off. A power supply VDD lower than the step-up voltage Vout is supplied to the driving signal generation circuit 30, and the driving signals G1 and G2 change to ground potential or to the potential of the power supply VDD. For example, the step-up voltage Vout is 400 V and the power supply VDD is several tens of volts. Further, as explained below, the control signal PWM is generated such that the voltage of the step-up power supply Vout becomes a desired voltage.

The switching circuit device 20 comprises a single chip; on the same chip are formed the high-voltage switching transistors Q1 and Q2, and ordinary-voltage transistors within the driving signal generation circuit 30 which cannot accept such high voltages. The switching transistors Q1 and Q2 and the transistors within the driving signal generation circuit are for example GaN HEMTs. In the case of HEMTs, as explained below, high-voltage transistors and ordinary-voltage transistors which accept lower voltages are formed on the same semiconductor substrate, and are included on a single chip.

Further, the transistors within the driving signal generation circuit 30, which in the above example are HEMTs, are transistors with narrower gate widths W and which are smaller in size compared with the transistors Q1 and Q2 which switch large currents. Hence the area on the chip occupied by the driving signal generation circuit 30 is small compared with the transistors Q1 and Q2.

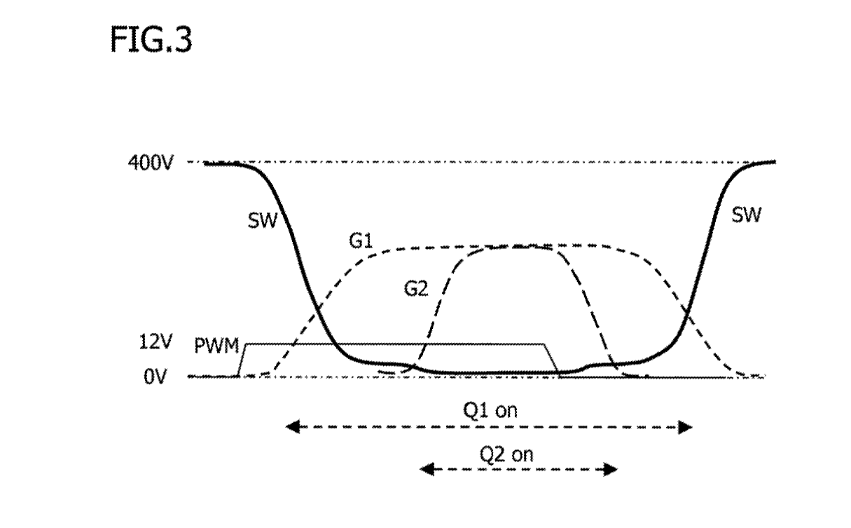

FIG. 3 is an operation waveform diagram of the switching circuit device 20 of FIG. 2. When both the first and second driving signals G1 and G2 are at ground potential which is L level, the first and second transistors Q1 and Q2 are both turned off (in the non-conducting state), and the first node SW is at high potential. In this state, when the control signal PWM rises from L level to H level (for example 12 V), in response the driving signal generation circuit 30 first raises the first driving signal G1 from L level to H level. In response, the first transistor Q1 is turned on (conducting state).

However, the gate width W of the first transistor Q1 is narrow, so that the transconductance gm is small, the on resistance is high, and the drain current is small. Consequently the first node SW declines gradually from high potential to approach ground potential. That is, the switching operation has a low slew rate, and rapid voltage changes is avoided. This means that the current change is small when the first transistor Q1 switches from off to on, and the voltage and electromagnetic noise due to the parasitic inductance Lp are small.

The driving signal generation circuit 30 raises the second driving signal G2 from L level to H level after a prescribed time delay from the rise of the first driving signal G1. In response to this, the second transistor Q2 is tuned on. The timing of the rise of this second driving signal G2 is the timing with which the potential of the first node SW declines to approach the (ground) potential of the second node VSS. When the second transistor Q2, with a wider gate width W, is conducting, the first node SW declines substantially to the ground potential of the second node VSS. The transconductance gm of the second transistor Q2 is high and the on resistance is low, so that losses may be kept small.

Next, while the first and second driving signals G1 and G2 are both at H level, and the first and second transistors Q1 and Q2 are turned on, the first node SW is at ground potential, and current is supplied to the inductor L1. By this means the inductor L1 stores energy.

In this state, when the control signal PWM falls from H level to L level, in response the driving signal generation circuit 30 first lowers the second driving signal G2 from H level to L level. In response, the second transistor Q2 turns off, and the first transistor Q1 is in the on state. Hence the current flowing from the inductor L1 to the switching circuit device 20 is reduced, and due to the small on current of the first transistor Q1, the potential of the first node SW rises slightly. After a prescribed time delay from this, the driving signal generation circuit 30 lowers the first driving signal G1 from H level to L level. In response, the first transistor Q1 turns off, and the potential of the first node SW rises gradually and reaches high voltage. That is, the switching operation has a low slew rate, and rapid voltage changes may be avoided. This means that due to operation of switching from on to off of the first transistor Q1 alone, which is small in size, rapid voltage change at the first node SW is avoided, and rapid current changes is also avoided.

The rising and falling of the first driving signal G1 are comparatively gradual changes due to the gate parasitic capacitance and similar; this also causes the change in transconductance gm of the first transistor Q1 to be gradual, and contributes to suppressing changes in current.

Thus in this embodiment, a plurality of switching transistors with different gate widths, which in the example of FIG. 2 are two switching transistors Q1 and Q2, are provided in parallel, and the driving signals G1 and G2 thereof are controlled so that rises and falls are shifted in time. By this means, current changes and voltage changes during switching are suppressed, the slew rate of the first node SW is lowered and voltage noise and electromagnetic noise are suppressed, and in addition the on resistance after switching is kept low and losses are suppressed, so that the efficiency of the power supply device may be raised.

In this embodiment, two transistors Q1 and Q2 are provided in parallel between the inductor L1 and the reference potential VSS. The gate widths of these transistors Q1 and Q2 may be equal. Based on a control signal PWM generated such that the output voltage Vout of the power supply circuit becomes equal to a desired potential (reference potential), driving signals G1 and G2 having a time difference are generated. That is, the driving signal generation circuit 30 adjusts the timing of the driving signals G1 and G2 from the timing of the control signal PWM to generate a time difference. Through this timing adjustment of the driving signals G1 and G2, during turn-on switching the switching circuit turns on the transistor Q1 first and then, after the time difference, turns on the transistor Q2, and during turn-off switching turns off the transistor Q2 first and then, after a time difference, turns off the transistor Q1. By turning on at least one among the two transistors, the slew rates of rising and falling of the potential at the node SW are lowered. By this means the rising and falling of the potential at the node SW becomes smooth, voltage noise and electromagnetic noise are suppressed, the on resistance is lowered and losses are suppressed.

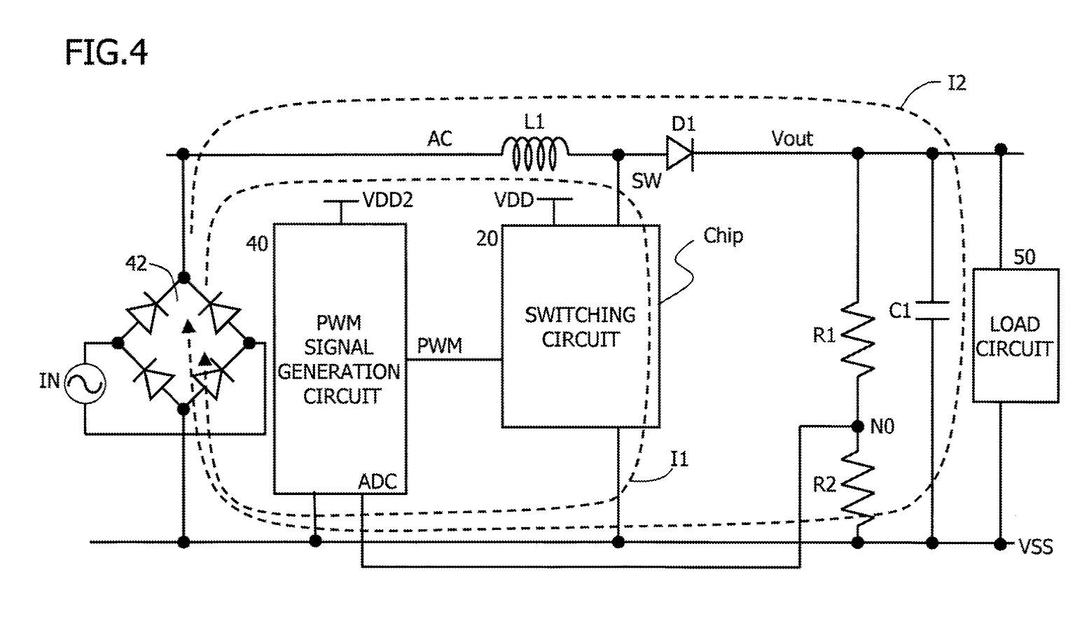

FIG. 4 is a circuit diagram of the power supply device in this embodiment. In addition to the inductor L1, diode D1 and switching circuit device 20 illustrated in FIG. 2, the power supply device of FIG. 4 has two resistors R1 and R2 which resistance-divide the stepped-up output voltage Vout; a PWM signal generation circuit 40 to which the voltage of the resistance-divided node N0 is fed back; an input power supply IN; a rectifying bridge circuit 42 comprising four diodes; and a stabilizing capacitor C1 provided at the output Vout. Further, a load circuit 50 to which the stepped-up voltage Vout is supplied appears in FIG. 4. The input power supply IN is an AC power supply or a DC power supply.

The PWM signal generation circuit 40 is a control signal generation circuit which generates a control signal PWM, and is for example an integrated circuit of a microcomputer or logic circuit (LSI) formed within the silicon chip. Hence the normal power supply VDD2 of a silicon LSI is supplied.

The feedback voltage of the node N0 is converted into a digital signal within the PWM signal generation circuit 40. The PWM signal generation circuit 40 generates a control signal PWM such that the feedback voltage becomes a desired voltage. As one example, the PWM signal generation circuit executes pulse width modulation control so as to lengthen the pulse width of the control signal PWM when the stepped-up voltage Vout is lower than the desired voltage, and to shorten the pulse width when the stepped-up voltage Vout is higher. Or, the PWM signal generation circuit holds the pulse width of the control signal PWM constant, and raises the pulse density when the stepped-up voltage Vout is lower than the desired voltage, and lowers the pulse density when the stepped-up voltage Vout is higher.

When the first and second transistors Q1 and Q2 within the switching circuit device 20 are turned on, a current I1 flows, and electromagnetic energy is stored in the inductor L1. On the other hand, when the first and second transistors Q1 and Q2 are turned off, the electromagnetic energy stored in the inductor L1 causes a current I2 to flow, and the step-up voltage Vout rises. By controlling this operation, the step-up voltage Vout is controlled to reach a desired potential.

On the other hand, as explained above, the switching circuit device 20 integrates within a single chip both high-voltage devices, such as for example GaN HEMTs, and low-voltage GaN HEMTs.

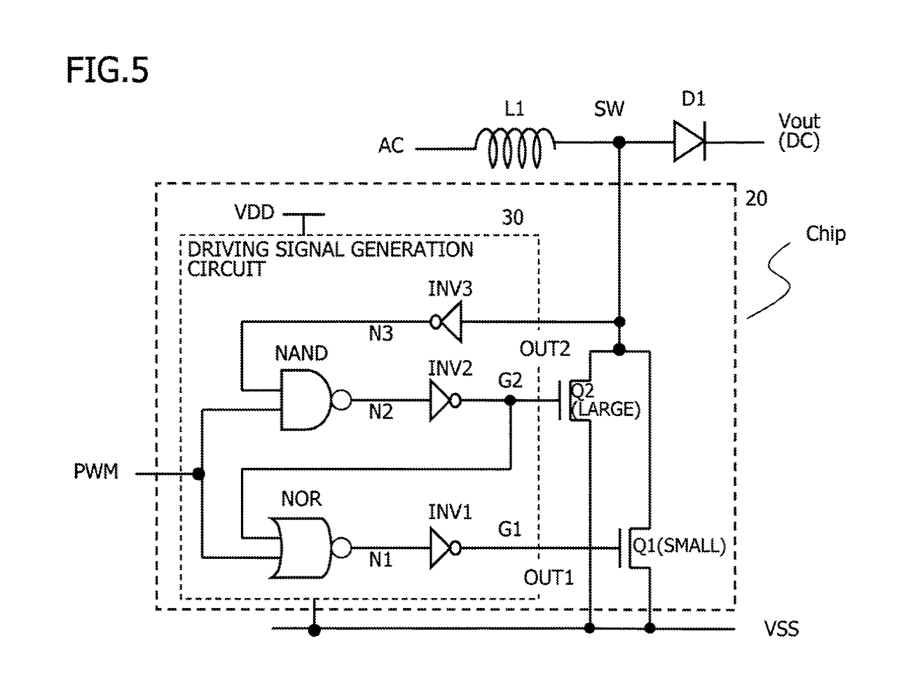

FIG. 5 illustrates a first circuit example of the driving signal generation circuit in this embodiment. With the transistors Q1 and Q2 in the off state, the control signal PWM is at L level and the first node SW is at H level, so that the output N3 of the inverter INV3 is at L level, the NAND output N2 is at H level, and the output G2 of the inverter INV2 is at L level. Further, the NOR output N1 is at H level, and the output G1 of the inverter INV1 is also at L level.

As illustrated in FIG. 3, when the transistors Q1 and Q2 are in the off state, the control signal PWM rises from L level to H level, the NOR output N1 goes to L level and the output G1 of the inverter INV1 goes to H level, and the first transistor Q1 is turned on. As a result, the potential at the first node SW gradually declines. When the potential at the first node SW declines to close to ground potential, the output N3 of the inverter INV3 goes to H level, and because PWM is at H level the NAND output N2 goes to L level and the output G2 of the inverter INV2 becomes at H level, so that the second transistor Q2 is turned on. In this way, by means of a delay circuit using the components NOR and INV1 and a delay circuit using the components INV3, NAND and INV2, in response to a rise in the control signal PWM the driving signal generation circuit 30 first raises the first driving signal G1 to H level and lowers the potential at the first node SW to near ground potential, and thereafter raises the second driving signal G2 to H level.

Conversely, when both transistors Q1 and Q2 are in the on state and the control signal PWM falls from H level to L level, first the NAND output N2 goes to H level and the second driving signal G2 which is the output of the inverter INV2 falls from H level to L level. As a result, the second transistor Q2 is first turned off. Then, due to the L level of the control signal PWM and the L level of the second driving signal G2, the NOR output N1 goes to H level, and the first driving signal G1 which is the output of the inverter INV1 also falls from H level to L level. As a result, the first transistor Q1 is turned off, lagging the transistor Q2. When the potential at the first node SW rises to a high potential, the output N3 of the inverter INV3 goes to L level.

No high voltages are applied to transistors in the driving signal generation circuit 30 other than those in the inverter INV3. Hence these comprise low-voltage HEMT transistors.

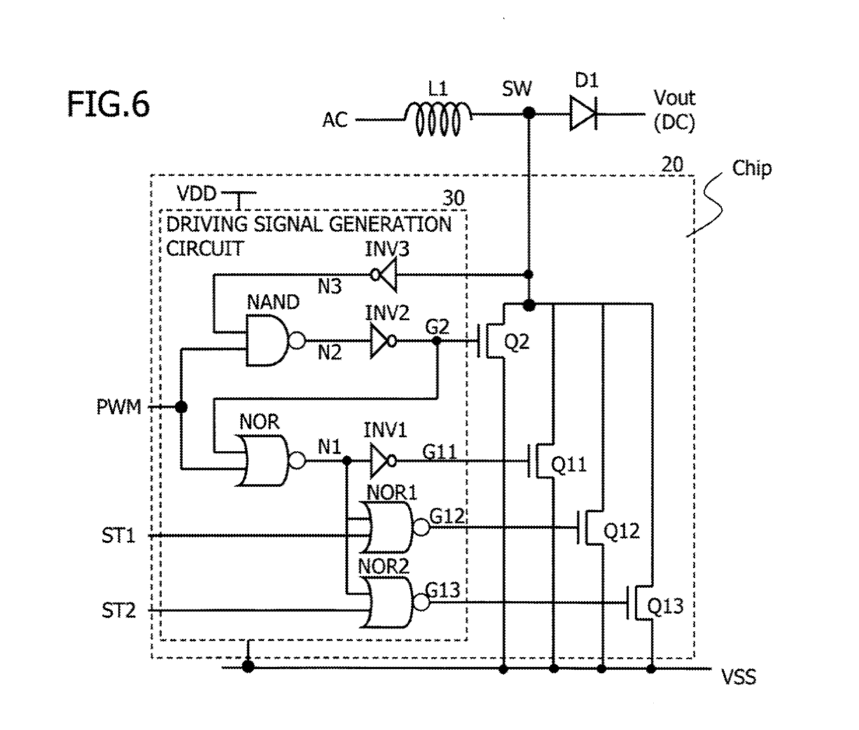

FIG. 6 illustrates a second circuit example of the driving signal generation circuit in this embodiment. In this example, as the first transistor Q1 with gate width narrower than that of the second transistor Q2, a plurality of transistors, in this example the three transistors Q11, Q12 and Q13, are provided in parallel. These three first transistors Q11, Q12, Q13 have gate widths narrower than that of the second transistor Q2, and have higher on resistances. Further, the gate widths of the three first transistors Q11, Q12, Q13 are for example in the ratio Q11:Q12:Q13=1:2:4.

As can be understood upon comparison with the circuit example of FIG. 5, the driving signal generation circuit 30 of FIG. 6, similarly to that of FIG. 5, has NAND, NOR, INV1, INV2, and INV3 components. The driving signal generation circuit 30 of FIG. 6 further has NOR gates NOR1 and NOR2 in parallel with the inverter INV1, and these NOR gates NOR1 and NOR2 output driving signals G12 and G13. In addition to the NOR output N1, these NOR gates NOR1 and NOR2 take as inputs setting signals ST1 and ST2.

If the setting signals ST1 and ST2 are both at L level, when the output G11 of the INV1 goes to H level the outputs G12 and G13 of NOR1 and NOR2 also go to H level, and the three first transistors Q11, Q12, Q13 are all turned on. If the setting signals ST1 and ST2 are at the L and H levels respectively, when the output G11 of the INV1 goes to H level, the output G12 of NOR1 goes to H level, and the two first transistors Q11 and Q12 are turned on while Q13 remains off. If the setting signals ST1 and ST2 are at the H and L levels respectively, the opposite of the above is true. If the setting signals ST1 and ST2 are both at H level, the transistors Q12 and Q13 are not turned on.

In this way, by changing the settings of the setting signals ST1 and ST2, the total gate width of the first transistors Q11, Q12, Q13 which are in the on state during switching is adjusted with a resolution of from 1 to 7-fold.

In the switching circuit device 20 provided in the power supply device, it is desirable that the slew rate of the potential at the first node SW during switching (the slope of the voltage change) be optimized by means of the magnitude of the inductor L1 in the power supply device, the magnitude of the parasitic capacitance of the first node SW, the allowed levels of voltage and electromagnetic noise, allowed losses, and similar. In the case of the switching circuit device of FIG. 6, the slew rate is optimized by means of the setting signals ST1 and ST2. The setting signals ST1 and ST2 are for example supplied from the control signal generation circuit 40, or are set by an external component.

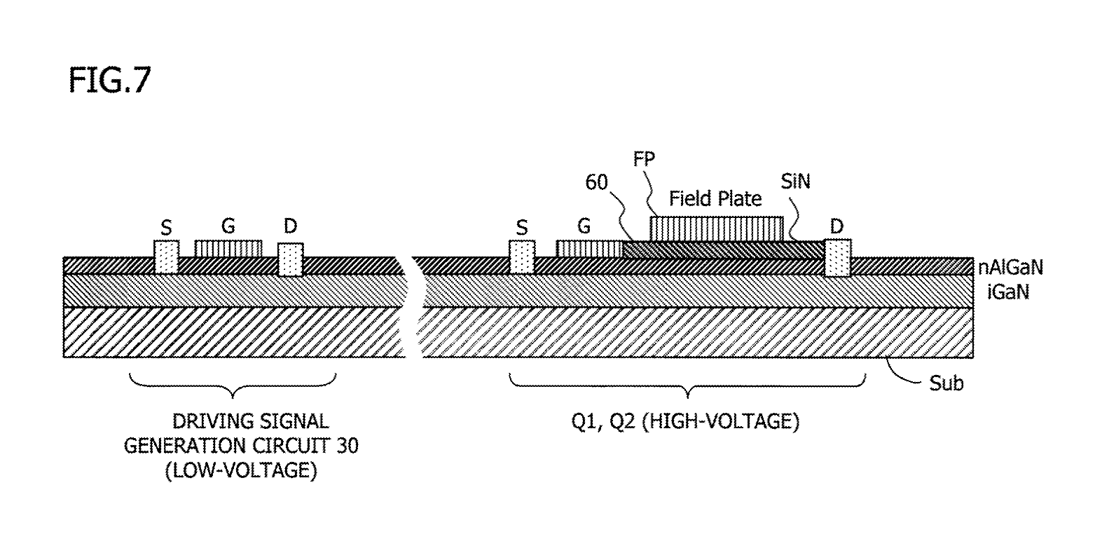

FIG. 7 is a cross-sectional view of a chip comprising a switching circuit device in this embodiment. As explained above, a driving signal generation circuit 30, which has low-voltage transistors forming the switching circuit device, and high-voltage switching transistors Q1 and Q2, are formed on the same semiconductor substrate. As illustrated in the cross-sectional view of FIG. 7, an iGaN layer which is an undoped electron transit layer (or channel layer), an nAlGaN layer which is an n-type electron supply layer, and a gate electrode G are provided on a silicon or GaN substrate Sub. A source electrode S and drain electrode D are provided on both sides of the gate electrode G. In this HEMT (High Electron Mobility Transistor), by controlling the voltage at the gate electrode G, electrons from the electron supply layer nAlGaN are supplied to the interface of the electron transit layer iGaN, and a channel is formed.

Such a GaN HEMT is made to handle higher voltages if the distance between the gate electrode G and the drain electrode D is lengthened. Hence as illustrated in FIG. 7, in the HEMTs within the driving signal generation circuit 30 the distance between the gate electrode G and drain electrode D is shortened, whereas in the HEMTs which are the power transistors Q1 and Q2 used as switching transistors, the distance between the gate electrode G and the drain electrode D is long.

Further, in the power transistors Q1 and Q2 a field plate electrode FP is provided on the insulating film SiN between the gate electrode G and the drain electrode D. Normally, the source electrode S and a field plate electrode FP are coupled, the source electrode is coupled to ground potential, and a high voltage, such as for example 400 V, is applied to the drain electrode D. A HEMT comprising a gate electrode G is an enhancement-type device with a positive threshold voltage, and a HEMT comprising a field plate electrode FP is a depression-type device with a negative threshold voltage of for example −100 V.

In turning on operation of a HEMT with this field plate electrode, the gate-source voltage rises to be equal to or above the threshold voltage, a channel is formed below the gate electrode G, and because the device is a depression-type device a channel is also formed below the field plate electrode FP, so that a channel is formed between the drain electrode D and the source electrode S. On the other hand, when the HEMT is turned off, the gate-source voltage falls below the threshold voltage and no channel is formed below the gate electrode G, and the potential at the node 60 between the gate electrode G and the field plate electrode FP rises. When the potential at the node 60 exceeds 100 V, the voltage across the field plate electrode FP coupled to the source electrode and the node 60 falls below the depression threshold voltage of −100 V, and no channel is formed below the field plate FP. Hence the HEMT is turned off in a state in which the voltage across the node 60 and source electrode S is 100 V and the voltage across the drain electrode D and node 60 is 300 V, and the high voltage of 400 V is divided. In this way, by providing the field plate electrode FP, the HEMT is made to handle high voltages.

On the other hand, in a HEMT within the driving signal generation circuit 30, a gate electrode G is formed between the drain electrode D and the source electrode S. Similarly to an ordinary HEMT, the distance between the gate electrode G and the drain electrode D is longer than the distance between the gate electrode G and the source electrode S. And, the distance between the gate electrode G and drain electrode D is shorter compared with that for the transistors Q1 and Q2, and voltages which is handled are also lower than for the transistors Q1 and Q2.

In this way, by using GaN HEMTs to form the switching circuit, the switching transistors Q1 and Q2 and the transistors within the driving signal generation circuit 30 are integrated on a single chip. In general, GaN (gallium nitride) has a high insulation breakdown electric field and is able to withstand high voltages even at small sizes, has a high saturation drift velocity and is capable of high-frequency switching, so that the inductor L1 and capacitor C1 may be made small, and moreover is said to have higher thermal conductivity than silicon.

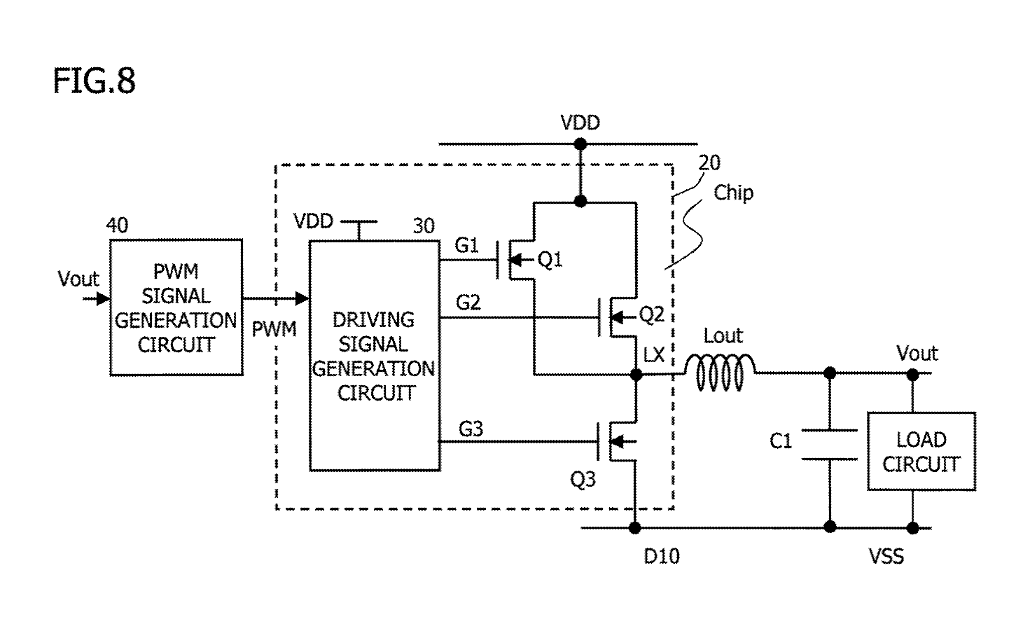

FIG. 8 is a circuit diagram of the power supply device of a second embodiment. This power supply device is a DC-DC converter which steps down an input DC power supply VDD to generate a DC power supply Vout. A switching circuit device 20 of this embodiment is also applied to such a step-down type power supply device.

High-voltage switching transistors Q1 and Q2 are provided between the input DC voltage VDD (first node) and the node LX (second node), and a high-voltage switching transistor Q3 is also provided between the node LX and ground VSS. Further, an external inductor Lout is provided between the node LX and the output Vout of the power supply device. A stabilizing capacitor C1 is provided at the output Vout, and the output voltage Vout is supplied to a load circuit. The output voltage Vout is fed back to a PWM signal generation circuit 40 which is a control signal generation circuit, and a control signal PWM is generated such that the PWM signal output voltage Vout becomes a desired voltage.

In this step-down type power supply device, operation alternates such that when the transistors Q1 and Q2 on the high side are turned on, the transistor Q3 on the low side is turned off, and when Q1 and Q2 are turned off Q3 is turned on. When the transistors Q1 and Q2 are turned on, the potential at the node LX rises to the input DC power supply VDD, current flows from the input DC power supply VDD to the inductor Lout, and electromagnetic energy is stored in the inductor. On the other hand, when the transistors Q1 and Q2 are turned off, the transistor Q3 is turned on, and the current flowing in the inductor Lout due to the stored electromagnetic energy flows from ground VSS via the transistor Q3. When the transistor Q3 is turned on the potential at the node LX falls to ground VSS or below. All of the transistors Q1, Q2 and Q3 have a low on resistance, and losses are kept small. The PWM signal generation circuit 40 which is the control signal generation circuit is similar to that in the step-up type power supply device of FIG. 4, and the PWM control signal either has a pulse width which is PWM-controlled, or has a pulse density which is PWM-controlled.

In this step-down type power supply device also, as the high-side switching transistors, a first transistor Q1 with a narrow gate width and a second transistor Q2 with a wider gate width are coupled in parallel. The first and second driving signals G1 and G2 generated by the driving signal generation circuit 30 are similar to those in FIG. 2 and FIG. 3. When the high-side switching transistors are turned on, the first driving signal G1 goes to H level first, and the transistor Q1 with the narrower gate width is turned on first. At this time the on resistance is high, so that the potential at the node LX gradually rises to the power supply VDD, and voltage noise and electromagnetic noise are kept low. After the transistor Q1 turns on and the potential at the node LX has risen to substantially the potential of the power supply VDD, the second driving signal G2 goes to H level, and transistor Q2 with the wider gate width is turned on. The on resistance of this transistor Q2 is low, so that losses are suppressed and high efficiency may be achieved.

The low-side switching transistor Q3 may be a single high-voltage HEMT transistor, or similarly to the high side, may comprise first and second transistors. In this case, the node LX is the first node, ground VSS is the second node, and the first and second transistors Q1 and Q2 are provided in parallel between the nodes.

As explained above, by means of this embodiment, high-voltage transistors Q1 and Q2 with different transistor sizes are provided in parallel between first and second nodes across which a high voltage is applied, and driving signals which drive these transistors are supplied with a time difference therebetween. When the transistors are turned on, the smaller-size transistor Q1 is turned on first, lowering the slew rate at which the voltage across the first and second nodes falls, and after the voltage across the first and second nodes has fallen sufficiently, the larger-size transistor Q2 is turned on, and the on resistance is kept low to suppress losses. On the other hand, when the transistors are turned off, the larger-size transistor Q2 is turned off first, lowering the slew rate at which the voltage across the first and second nodes rises, and after the voltage difference between the two nodes is sufficiently high, the smaller transistor Q1 is turned off.

Further, by using GaN HEMTs for the high-voltage transistors Q1 and Q2 and for the low-voltage transistors in the driving signal generation circuit, a single-chip switching circuit device is made possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

1. A switching circuit device provided between a first node and a second node within a power supply circuit, with an inductor being coupled to the first or second node,
the switching circuit device comprising:
a first transistor that is provided between the first node and the second node and has a first gate width;
a second transistor that is provided in parallel with the first transistor between the first node and the second node and has a second gate width larger than the first gate width; and
a driving signal generation circuit, which, in response to a control signal generated according to an output voltage of the power supply circuit, outputs a first driving signal which drives the first transistor on and off, and a second driving signal which drives the second transistor on and off, with different timings between the first driving signal output and the second driving signal output.

2. The switching circuit device according to claim 1, wherein the driving signal generation circuit shifts the timing of a first change of the first and second driving signals such that after the first transistor is driven to turn on, sand second transistor is driven to turn on, and shifts the timing of a second change of the first and second driving signals such that after the second transistor is driven to turn off, the first transistor is driven to turn off.

3. The switching circuit device according to claim 2, wherein the driving signal generation circuit controls the first change of the first and second driving signals such that the first transistor is driven to turn on, and after the voltage across the first node and the second node has fallen to a prescribed voltage, the second transistor is driven to turn on.

4. The switching circuit device according to claim 2, wherein the driving signal generation circuit has a delay circuit that, in response to a first change in the control signal, generates a first change in the first driving signal and thereafter generates a first change in the second driving signal, and in response to a second change in the control signal, generates a second change in the second driving signal and thereafter generates a second change in the first driving signal.

5. The switching circuit device according to claim 1, wherein
the first and second transistors, and a third transistor forming the driving signal generation circuit, are formed on a common semiconductor substrate,
the first and second transistors are first HEMTs with a first distance being provided between a gate and a drain, and
the third transistor is a second HEMT with a second distance, which is shorter than the first distance, being provided between a gate and a drain.

6. The switching circuit device according to claim 1, wherein the control signal has a pulse width or a frequency according to an output voltage of the power supply circuit.

7. A power supply device, comprising:
the switching circuit device according to claim 1;
an inductor that is coupled to the first node; and
a unidirectional element that is provided between the first node and an output terminal.

8. A power supply device, comprising:
the switching circuit device according to claim 1;
an input voltage that is coupled to the first node; and
an inductor that is provided between the second node and an output terminal.

9. The power supply device according to claim 8, further comprising a low-side transistor provided between the second node and a reference power supply.

10. A power supply device, comprising:
the switching circuit device according to claim 1;
a high-side transistor that is provided between an input voltage and the first node; and
an inductor that is provided between the first node and an output terminal.

11. A switching circuit device of power supply circuit,
the device comprising:
a first transistor provided between an inductor and a reference potential;
a second transistor provided in parallel with the first transistor between the inductor and the reference potential; and
an adjustment circuit that, in response to a magnitude relation between the output voltage and a prescribed voltage, imparts a time difference between a first control signal which drives the first transistor and a second control signal which drives the second transistor.
